(19) United States
(12) Patent Application Publication
(10) Pub. No.: US 2014/0354559 A1
(43) Pub. Date: Dec. 4, 2014

(54) ELECTRONIC DEVICE AND PROCESSING METHOD

(71) Applicant: KABUSHIKI KAISHA TOSHIBA, Tokyo (JP)

(72) Inventors: Yoshikazu Terunuma, Ome-shi (JP); Takehiko Demiya, Mitaka-shi (JP)

(73) Assignee: KABUSHIKI KAISHA TOSHIBA, Tokyo (JP)

(21) Appl. No.: 14/147,374

(22) Filed: Jan. 3, 2014

Related U.S. Application Data
(63) Continuation of application No. PCT/JP2013/065100, filed on May 30, 2013.

(51) Int. Cl. G06K 9/22; G06F 3/041

(52) U.S. Cl. CPC G06K 9/222; G06F 3/041
USPC 345/173

(57) ABSTRACT

According to one embodiment, an electronic device displays, on a touch-screen display, a content in a display area and a bar comprising at least one first software button of an operating system at a first location on the bar. The bar is located under the display area. The electronic device changes a display location of the first software button on the bar to either a right side or a left side of the first location, in response to detection of a transition to an active state of a first application program configured to enable a handwriting input on the display area of the screen.

### CROSS REFERENCE TO RELATED APPLICATIONS

This application is a Continuation Application of PCT Application No. PCT/JP2013/065100, filed May 30, 2013, the entire contents of which are incorporated herein by reference.

### FIELD

Embodiments described herein relate generally to a technique of processing a handwritten document.

### BACKGROUND

In recent years, various kinds of electronic devices, such as a tablet, a PDA and a smartphone, have been developed. Most of these electronic devices include touch-screen displays for facilitating input operations by users.

By touching a menu or an object, which is displayed on the touch-screen display, by a finger or the like, the user can instruct an electronic device to execute a function which is associated with the menu or object.

However, most of existing electronic devices with touch-screen displays are consumer products which are designed to enhance operability on various media data such as image and music, and are not necessarily suitable for use in a business situation such as a meeting, a business negotiation or product development. Thus, in business situations, paper-based pocket notebooks have still been widely used.

Recently, an electronic device which can execute a handwriting input has begun to be developed. The electronic device which can execute a handwriting input is required to suppress drawing by an unintentional touch operation by a user on a screen while a handwriting input is being executed.

As a function for suppressing an unintentional touch operation, a so-called “palm rejection” function is known. The palm rejection function enables the user to handwrite with use of a pen in a state in which the palm is in contact with a handwriting input area.

Conventionally, however, no consideration has been given to a technique of suppressing an unintentional touch operation on software buttons (e.g. icons, buttons) of an operating system on the screen.

### BRIEF DESCRIPTION OF THE DRAWINGS

A general architecture that implements the various features of the embodiments will now be described with reference to the drawings. The drawings and the associated descriptions are provided to illustrate the embodiments and not to limit the scope of the invention.

FIG. 1 is an exemplary perspective view illustrating an external appearance of an electronic device according to an embodiment.

FIG. 2 is an exemplary view illustrating a cooperative operation between the electronic device of the embodiment and an external apparatus.

FIG. 3 is a view illustrating an example of a handwritten document which is handwritten on a touch-screen display of the electronic device of the embodiment.

FIG. 4 is an exemplary view for explaining time-series information corresponding to the handwritten document of FIG. 3, the time-series information being stored in a storage medium by the electronic device of the embodiment.

FIG. 5 is an exemplary block diagram illustrating a system configuration of the electronic device of the embodiment.

FIG. 6 is an exemplary view for describing structural elements of a screen of the electronic device of the embodiment.

FIG. 7 is a view illustrating an example of the screen at a time when a handwriting note application program, which is executed by the electronic device of the embodiment, is in an active state.

FIG. 8 is a view illustrating a state in which a display location of software buttons of the operating system has been changed to a left side of a default display location by the electronic device of the embodiment.

FIG. 9 is a view illustrating a state in which the display location of the software buttons of the operating system has been changed to a right side of the default display location by the electronic device of the embodiment.

FIG. 10 is a view illustrating an example of a button display position setup screen which is displayed by the electronic device of the embodiment.

FIG. 11 is an exemplary view for explaining a cooperative operation between the handwriting note application program and the operating system, which are executed by the electronic device of the embodiment.

FIG. 12 is an exemplary view illustrating a desktop screen which is displayed by the electronic device of the embodiment.

FIG. 13 is an exemplary view illustrating a setup screen which is displayed by the electronic device of the embodiment.

FIG. 14 is an exemplary view illustrating a note preview screen which is displayed by the electronic device of the embodiment.

FIG. 15 is an exemplary view illustrating a page edit screen which is displayed by the electronic device of the embodiment.

FIG. 16 is an exemplary view illustrating a search dialogue which is displayed by the electronic device of the embodiment.

FIG. 17 is an exemplary view illustrating a screen of a browser, which is displayed by the electronic device of the embodiment.

FIG. 18 is an exemplary view illustrating a page edit screen on which a captured screen image of a browser is displayed, the page edit screen being displayed by the electronic device of the embodiment.

FIG. 19 is an exemplary block diagram illustrating a functional configuration of the handwriting note application program which is executed by the electronic device of the embodiment.

FIG. 20 is an exemplary flowchart illustrating the procedure of a software button display control process which is executed by the electronic device of the embodiment.

FIG. 21 is an exemplary flowchart illustrating the procedure of a series of processes which are executed in response to an operation of a memo button displayed by the electronic device of the embodiment.

### DETAILED DESCRIPTION

Various embodiments will be described hereinafter with reference to the accompanying drawings.

In general, according to one embodiment, an electronic device includes a display processor and a controller. The display processor displays, on a touch-screen display, a content in a display area and a bar comprising at least one first software button of an operating system at a first location on the bar. The bar is located under the display area. The controller changes a display location of the first software button on the bar to either a right side or a left side of the first location, in response to detection of a transition to an active state of a first application program configured to enable a handwriting input on the display area of the screen.

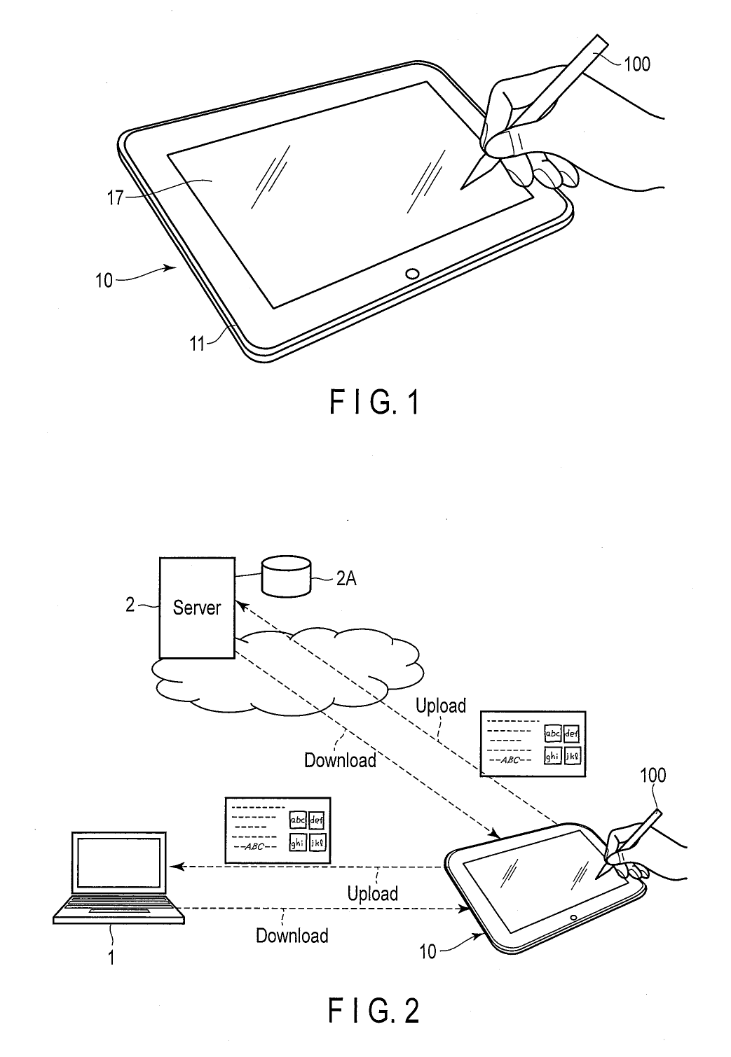

FIG. 1 is a perspective view illustrating an external appearance of an electronic device according to an embodiment. The electronic device is, for instance, pen-based portable electronic device which can execute a handwriting input by a pen or a finger. This electronic device may be realized as a tablet computer, a notebook-type personal computer, a smartphone, a PDA, etc. In the description below, the case is assumed that this electronic device is realized as a tablet computer 10. The tablet computer 10 is a portable electronic device which is also called tablet or slate computer. As shown in FIG. 1, the tablet computer 10 includes a main body 11 and a touch-screen display 17. The touch-screen display 17 is attached such that the touch-screen display 17 is laid over the top surface of the main body 11.

The main body 11 has a thin box-shaped housing. In the touch-screen display 17, a flat-panel display and a sensor, which is configured to detect a touch position of a pen or a finger on the screen of the flat-panel display, are assembled. The flat-panel display may be, for instance, a liquid crystal display (LCD). As the sensor, for example, use may be made of an electrostatic capacitance-type touch panel, or an electromagnetic induction-type digitizer. In the description below, the case is assumed that two kinds of sensors, namely a digitizer and a touch panel, are both assembled in the touch-screen display 17.

The touch-screen display 17 can detect not only a touch operation on the screen with use of a finger, but also a touch operation on the screen with use of a pen 100. The pen 100 may be, for instance, a digitizer pen (electromagnetic-induction pen). The user can execute a handwriting input operation on the touch-screen display 17 by using the pen 100. During the handwriting input operation, a locus of movement of the pen 100 on the screen, that is, a stroke (a locus of a handwritten stroke) which is handwritten by a handwriting input operation, is drawn in real time, and thereby plural strokes, which have been input by handwriting, are displayed on the screen. A locus of movement of the pen 100 during a time in which the pen 100 is in contact with the screen corresponds to one stroke. A set of many strokes corresponding to handwritten characters, handwritten graphics or handwritten tables constitutes a handwritten document.

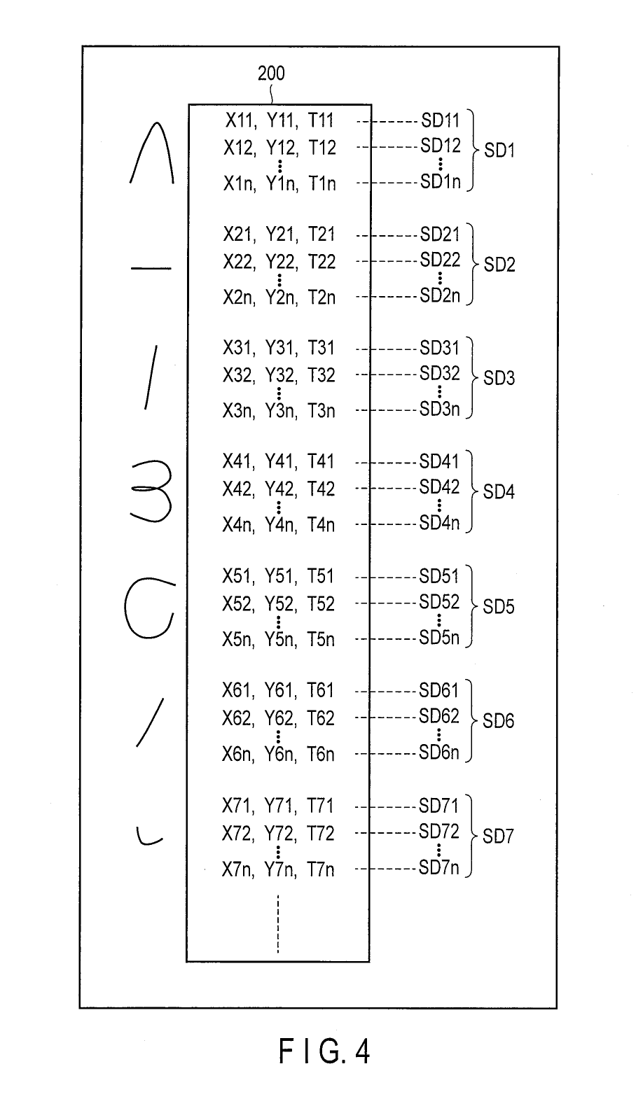

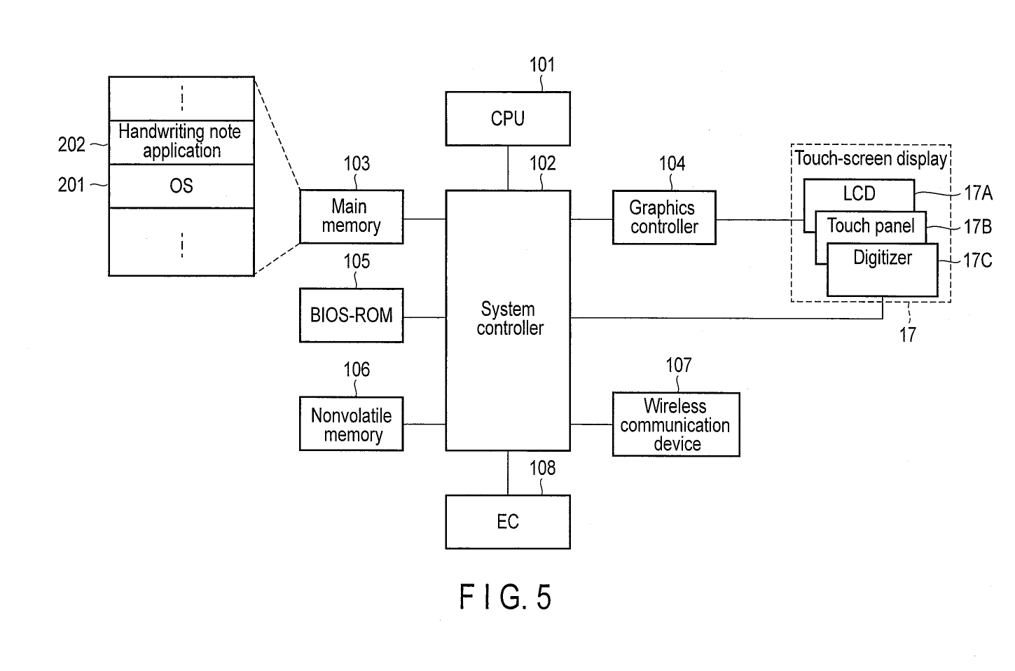

In the present embodiment, this handwritten document is stored in a storage medium not as image data but as time-series information (handwritten document data) indicative of coordinate series of the loci of strokes and the order relation between the strokes. The details of this time-series information will be described later with reference to FIG. 4. This time-series information indicates an order in which a plurality of strokes are handwritten, and includes a plurality of stroke data corresponding to a plurality of strokes. In other words, the time-series information means a set of time-series stroke data corresponding to a plurality of strokes. Each stroke data corresponds to one stroke, and includes coordinate data series (time-series coordinates) corresponding to points on the locus of this stroke. The order of arrangement of these stroke data corresponds to an order in which strokes were handwritten.

The tablet computer 10 can read out arbitrary existing time-series information from the storage medium, and can display on the screen a handwritten document corresponding to this time-series information, that is, a plurality of strokes indicated by this time-series information. A plurality of strokes indicated by the time-series information are also a plurality of strokes which are input by handwriting.

Furthermore, the tablet computer 10 of the embodiment includes a touch input mode for executing a handwriting input operation by a finger, without using the pen 100. When the touch input mode is enabled, the user can execute a handwriting input operation on the touch-screen display 17 by using a finger. During the handwriting input operation, a locus of movement of the finger on the screen, that is, a stroke (a locus of a handwritten stroke) which is handwritten by a handwriting input operation, is drawn in real time. Thereby, a plurality of strokes, which have been input by handwriting, are displayed on the screen.

In addition, the tablet computer 10 has an edit function. The edit function can delete or move an arbitrary handwritten part (a handwritten character, a handwritten mark, a handwritten graphic, a handwritten table, etc.) in a displayed handwritten document, which is selected by a range select tool, in accordance with an edit operation by the user with use of an “eraser” tool, the range select tool, and other various tools. Besides, an arbitrary handwritten part in a handwritten document, which is selected by the range select tool, can be designated as a search key for searching for a handwritten document. Moreover, a recognition process, such as handwritten character recognition/handwritten graphic recognition/handwritten table recognition, can be executed on an arbitrary handwritten part in a handwritten document, which is selected by the range select tool.

In this embodiment, a handwritten document may be managed as one page or plural pages. In this case, the time-series information (handwritten document data) may be divided in units of an area which falls within one screen, and thereby a piece of time-series information, which falls within one screen, may be stored as one page. Alternatively, the size of one page may be made variable. In this case, since the size of a page can be increased to an area which is larger than the size of one screen, a handwritten document of an area larger than the size of the screen can be handled as one page. When one whole page cannot be displayed on the display at a time, this page may be reduced in size and displayed, or a display target part in the page may be moved by vertical and horizontal scroll.

FIG. 2 shows an example of a cooperative operation between the tablet computer 10 and an external apparatus. The tablet computer 10 can cooperate with a personal computer 1 or a cloud. Specifically, the tablet computer 10 includes a wireless communication device of, e.g. wireless LAN, and can wirelessly communicate with the personal computer 1. Further, the tablet computer 10 can communicate with a server 2 on the Internet. The server 2 may be a server which executes an online storage service, and other various cloud computing services.

The personal computer 1 includes a storage device such as a hard disk drive (HDD). The tablet computer 10 can transmit time-series information (handwritten document data) to the personal computer 1 over a network, and can store the time-series information (handwritten document data) in the HDD of the personal computer 1 (“upload”). In order to ensure a secure communication between the tablet computer 10 and personal computer 1, the personal computer 1 may authenticate the tablet computer 10 at a time of starting the communication. In this case, a dialog for prompting the user to input an ID or a password may be displayed on the screen of the tablet computer 10, or the ID of the tablet computer 10, for example, may be automatically transmitted from the tablet computer 10 to the personal computer 1.

Thereby, even when the capacity of the storage in the tablet computer 10 is small, the tablet computer 10 can handle many pieces of time-series information or large-volume time-series information.

In addition, the tablet computer 10 can read out (“download”) at least one arbitrary handwritten document stored in the HDD of the personal computer 1, and can display strokes indicated by the read-out handwritten document on the screen of the display 17 of the tablet computer 10. In this case, the tablet computer 10 may display on the screen of the display 17 a list of thumbnails which are obtained by reducing in size pages of plural pieces of time-series information, or may display one page, which is selected from these thumbnails, on the screen of the display 17 in the normal size.

Furthermore, the destination of communication of the tablet computer 10 may be not the personal computer 1, but the server 2 on the cloud which provides storage services, etc., as described above. The tablet computer 10 can transmit time-series information (handwritten document data) to the server 2 over the network, and can store the time-series information in a storage device 2A of the server 2 (“upload”). Besides, the tablet computer 10 can read out arbitrary time-series information which is stored in the storage device 2A of the server 2 (“download”) and can display the loci of strokes indicated by the time-series information on the screen of the display 17 of the tablet computer 10.

As has been described above, in the present embodiment, the storage medium in which time-series information is stored may be the storage device in the tablet computer 10, the storage device in the personal computer 1, or the storage device in the server 2.

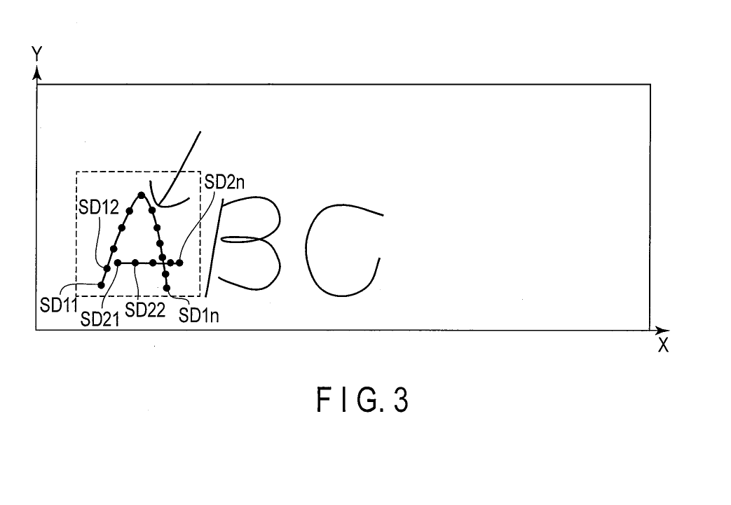

Next, referring to FIG. 3 and FIG. 4, a description is given of a relationship between strokes (characters, graphics, tables, etc.), which are handwritten by the user, and time-series information. FIG. 3 shows an example of a handwritten document (handwritten character string) which is handwritten on the touch-screen display 17 by using the pen 100 or the like.

In many cases, on a handwritten document, other characters or graphics are handwritten over already handwritten characters or graphics. In FIG. 3, the case is assumed that a handwritten character string “ABC” was handwritten in the order of “A”, “B” and “C”, and thereafter a handwritten arrow was handwritten near the handwritten character “A”.

The handwritten character “A” is expressed by two strokes (a locus of “̂” shape, a locus of “-” shape) which are handwritten by using the pen 100 or the like, that is, by two loci. The locus of the pen 100 of the first handwritten “̂” shape is sampled in real time, for example, at regular time intervals, and thereby time-series coordinates SD11, SD12, . . . , SD1n of the stroke of the “̂” shape are obtained. Similarly, the locus of the pen 100 of the next handwritten “-” shape is sampled in real time, for example, at regular time intervals, and thereby time-series coordinates SD21, SD22, . . . , SD2n of the stroke of the “-” shape are obtained.

The handwritten character “B” is expressed by two strokes which are handwritten by using the pen 100 or the like, that is, by two loci. The handwritten character “C” is expressed by one stroke which is handwritten by using the pen 100 or the like, that is, by one locus. The handwritten “arrow” is expressed by two strokes which are handwritten by using the pen 100 or the like, that is, by two loci.

FIG. 4 illustrates time-series information 200 corresponding to the handwritten document of FIG. 3. The time-series information 200 includes a plurality of stroke data SD1, SD2, . . . , SD7. In the time-series information 200, the stroke data SD1, SD2, . . . , SD7 are arranged in time series in the order in which the strokes were handwritten.

In the time-series information 200, the first two stroke data SD1 and SD2 are indicative of two strokes of the handwritten character “A”. The third and fourth stroke data SD3 and SD4 are indicative of two strokes which constitute the handwritten character “B”. The fifth stroke data SD5 is indicative of one stroke which constitutes the handwritten character “C”. The sixth and seventh stroke data SD6 and SD7 are indicative of two strokes which constitute the handwritten “arrow”.

Each stroke data includes coordinate data series (time-series coordinates) corresponding to one stroke, that is, a plurality of coordinates corresponding to a plurality of points on the locus of one stroke. In each stroke data, the plural coordinates are arranged in time series in the order in which the stroke is written. For example, as regards handwritten character “A”, the stroke data SD1 includes coordinate data series (time-series coordinates) corresponding to the points on the locus of the stroke of the “̂” shape of the handwritten character “A”, that is, an n-number of coordinate data SD11, SD12, . . . , SD1n. The stroke data SD2 includes coordinate data series corresponding to the points on the locus of the stroke of the “-” shape of the handwritten character “A”, that is, an n-number of coordinate data SD21, SD22, . . . , SD2n. Incidentally, the number of coordinate data may differ between respective stroke data.

Each coordinate data is indicative of an X coordinate and a Y coordinate, which correspond to one point in the associated locus. For example, the coordinate data SD11 is indicative of an X coordinate (X11) and a Y coordinate (Y11) of the starting point of the stroke of the “̂” shape. The coordinate data SD1n is indicative of an X coordinate (X1n) and a Y coordinate (Y1n) of the end point of the stroke of the “̂” shape.

Further, each coordinate data may include time stamp information T corresponding to a time point at which a point corresponding to this coordinate data was handwritten. The time point at which the point was handwritten may be either an absolute time (e.g. year/month/day/hour/minute/second) or a relative time with reference to a certain time point. For example, an absolute time (e.g. year/month/day/hour/minute/second) at which a stroke began to be handwritten may be added as time stamp information to each stroke data, and furthermore a relative time indicative of a difference from the absolute time may be added as time stamp information T to each coordinate data in the stroke data.

In this manner, by using the time-series information in which the time stamp information T is added to each coordinate data, the temporal relationship between strokes can be more precisely expressed.

Moreover, information (Z) indicative of a pen stroke pressure may be added to each coordinate data.

The time-series information 200 having the structure as described with reference to FIG. 4 can express not only the trace of handwriting of each stroke, but also the temporal relation between strokes. Thus, with the use of the time-series information 200, even if a distal end portion of the handwritten “arrow” is written over the handwritten character “A” or near the handwritten character “A”, as shown in FIG. 3, the handwritten character “A” and the distal end portion of the handwritten “arrow” can be treated as different characters or graphics.

Furthermore, in the present embodiment, as described above, handwritten document data is stored not as an image or a result of character recognition, but as the time-series information 200 which is composed of a set of time-series stroke data. Thus, handwritten characters can be handled, without depending on languages of the handwritten characters. Therefore, the structure of the time-series information 200 of the embodiment can be commonly used in various countries of the world where different languages are used.

FIG. 5 shows a system configuration of the tablet computer 10.

As shown in FIG. 5, the tablet computer 10 includes a CPU 101, a system controller 102, a main memory 103, a graphics controller 105, a BIOS-ROM 105, a nonvolatile memory 106, a wireless communication device 107, and an embedded controller (EC) 108.

The CPU 101 is a processor which controls the operations of various modules in the tablet computer 10. The CPU 101 executes various kinds of software, which are loaded from the nonvolatile memory 106 that is a storage device into the main memory 103. The software includes an operating system (OS) 201 and various application programs. The application programs include a handwriting note application program 202. The handwriting note application program 202 includes a function of creating and displaying the above-described handwritten document data, a function of editing the handwritten document data, and a handwritten document search function for searching for handwritten document data including a desired handwritten part, or searching for a desired handwritten part in certain handwritten document data.

In addition, the CPU 101 executes a basic input/output system (BIOS) which is stored in the BIOS-ROM 105. The BIOS is a program for hardware control.

The system controller 102 is a device which connects a local bus of the CPU 101 and various components. The system controller 102 includes a memory controller which access-controls the main memory 103. In addition, the system controller 102 includes a function of communicating with the graphics controller 104 via, e.g. a PCI EXPRESS serial bus.

The graphics controller 104 is a display controller which controls an LCD 17A that is used as a display monitor of the tablet computer 10. A display signal, which is generated by the graphics controller 104, is sent to the LCD 17A. The LCD 17A displays a screen image based on the display signal. A touch panel 17B, LCD 17A and a digitizer 17C are laid over each other. The touch panel 17B is an electrostatic capacitance-type pointing device for executing an input on the screen of the LCD 17A. A contact position on the screen, which is touched by a finger, and a movement of the contact position are detected by the touch panel 17B. The digitizer 17C is an electromagnetic induction-type pointing device for executing an input on the screen of the LCD 17A. A contact position on the screen, which is touched by the pen (digitizer pen) 100, and a movement of the contact position are detected by the digitizer 17C.

The wireless communication device 107 is a device configured to execute wireless communication such as wireless LAN or 3G mobile communication. The EC 108 is a one-chip microcomputer including an embedded controller for power management. The EC 108 includes a function of powering on or powering off the tablet computer 10 in accordance with an operation of a power button by the user.

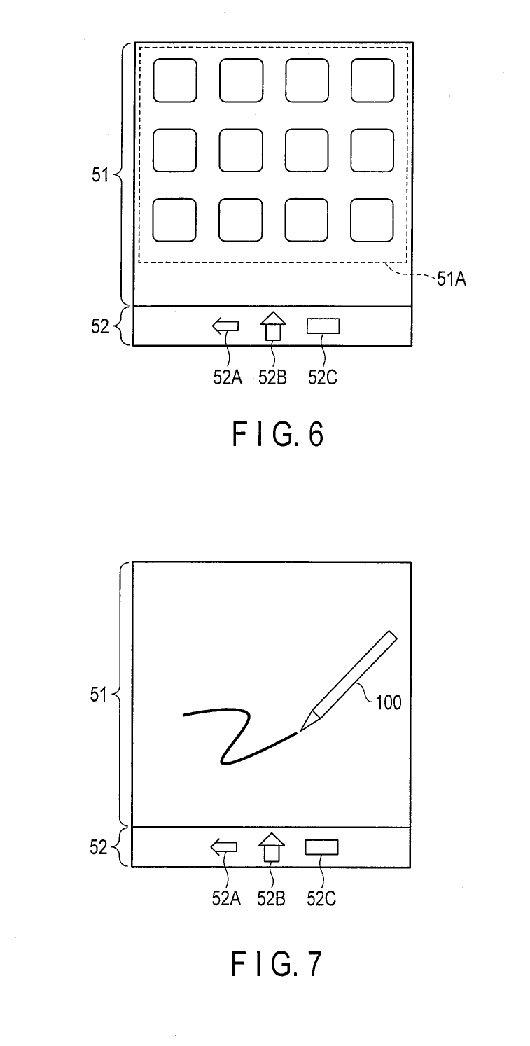

FIG. 6 illustrates structural elements of a screen which is displayed on the touch-screen display 17.

The screen includes a display area (also referred to as “content area”) 51 and a bar (also referred to as “navigation bar”) 52 under the display area 51. The display area 51 is an area for displaying content. The content of an application, which is in an active state, is displayed on the display area 51. In FIG. 6, it is assumed that a launcher program is in an active state. In this case, a plurality of icons 51A, which correspond to a plurality of application programs, are displayed on the display area 51 by the launcher program.

In the meantime, that a certain application program is in an active state means that this application program transitions to a foreground and, in other words, that this application program is running and focused.

The bar 52 is an area for displaying at least one software button (also referred to as “software key”) of the OS 201. Predetermined functions are assigned to the respective software buttons. If a certain software button is tapped by a finger or pen 100, the function assigned to this software button is executed by the OS 201. For example, in an Android™ environment, as shown in FIG. 6, a back button 52A, a home button 52B and a recent application button 52C are displayed on the bar 52. These software buttons are displayed at a default display location on the bar 52. In FIG. 6, the case is assumed that the default display location of these software buttons is a central part on the bar 52.

FIG. 7 illustrates an example of the screen at a time when the handwriting note application program 202 is in an active state.

The handwriting note application program 202 can selectively display various views (screens) on the display area 51. These views (screens) include a page edit screen. The page edit screen is a screen which enables a handwriting input on the above-described display area 51, and the page edit screen is used as a screen for viewing and editing a handwritten page. While the page edit screen is being displayed on the display area 51, almost the entirety of the display area 51 can be used as a handwriting input area. The handwriting note application program 202 can display on the display area 51 a plurality of handwritten strokes in accordance with a movement of the pen 100 on the handwriting input area, which is detected with use of the digitizer 17C. In addition, the handwriting note application program 202 can also execute a process corresponding to a gesture of a finger on the display area 51 (handwriting input area), for example, a page forward operation or a page back operation.

Software buttons are displayed at a default display location on the bar 52. It is thus possible that during a handwriting input operation, the user's hand erroneously comes in contact with a certain software button (back button 52A, home button 52B, or recent application button 52C) on the bar 52 (occurrence of an unintentional touch operation), resulting in execution of a process which is not intended by the user.

Taking the above into account, the tablet computer 10 of the embodiment includes a function of automatically changing the display location of the three software buttons (back button 52A, home button 52B and recent application button 52C) on the bar 52, according to whether the handwriting note application program 202 is active or not. This function may be realized by, for example, a cooperative operation between the handwriting note application program 202 and the OS 201.

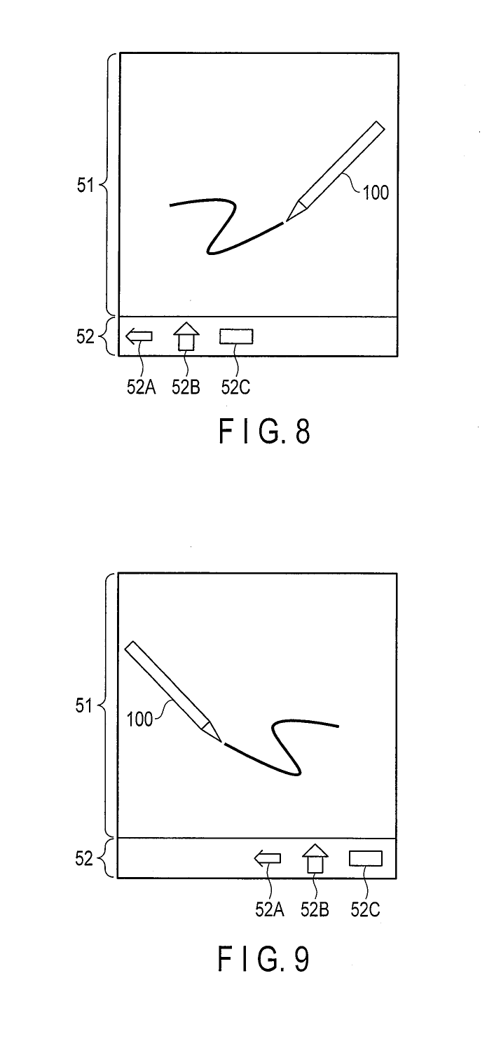

FIG. 8 illustrates a state in which the three software buttons (back button 52A, home button 52B and recent application button 52C) are displayed on a left part on the bar 52. In this case, it should suffice if the three software buttons are displayed on the left side of the default display location (the central part in this case). For example, the three software buttons may be displayed on a left half part on the bar 52, or may be displayed on a left end part on the bar 52.

When the user holds the pen 100 by the right hand, it is highly possible that the right hand comes in contact with a right part on the bar 52. Thus, as shown in FIG. 8, by changing the display location of the three software buttons to the left side of the default display location (central part), it becomes possible to suppress occurrence of an unintentional touch operation.

FIG. 9 illustrates a state in which the three software buttons (back button 52A, home button 52B and recent application button 52C) are displayed on a right part on the bar 52. When the user holds the pen 100 by the left hand, it is highly possible that the left hand comes in contact with a left part on the bar 52. Thus, as shown in FIG. 9, by changing the display location of the three software buttons to the right side of the default display location (central part), it becomes possible to suppress occurrence of an unintentional touch operation. It should suffice if the three software buttons are displayed on the right side of the default display location (the central part in this case). For example, the three software buttons may be displayed on a right half part on the bar 52, or may be displayed on a right end part on the bar 52.

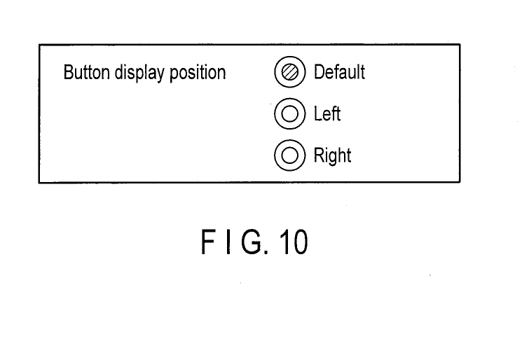

FIG. 10 illustrates an example of a button display position setup screen which is displayed by the handwriting note application program 202.

The button display position setup screen displays a “default” button, a “left” button and a “right” button. By tapping any one of the “default” button, “left” button and “right” button by a finger or pen 100, the user can set the position of the three software buttons, which are displayed when the handwriting note application program 202 is active, to any one of the default display location, a left-side position of the default display location and a right-side position of the default display location.

If the default display location is the right part of the bar 52, the button display position setup screen may be configured to include only the “default” button and “left” button. In addition, if the default display location is the left part of the bar 52, the button display position setup screen may be configured to include only the “default” button and “right” button.

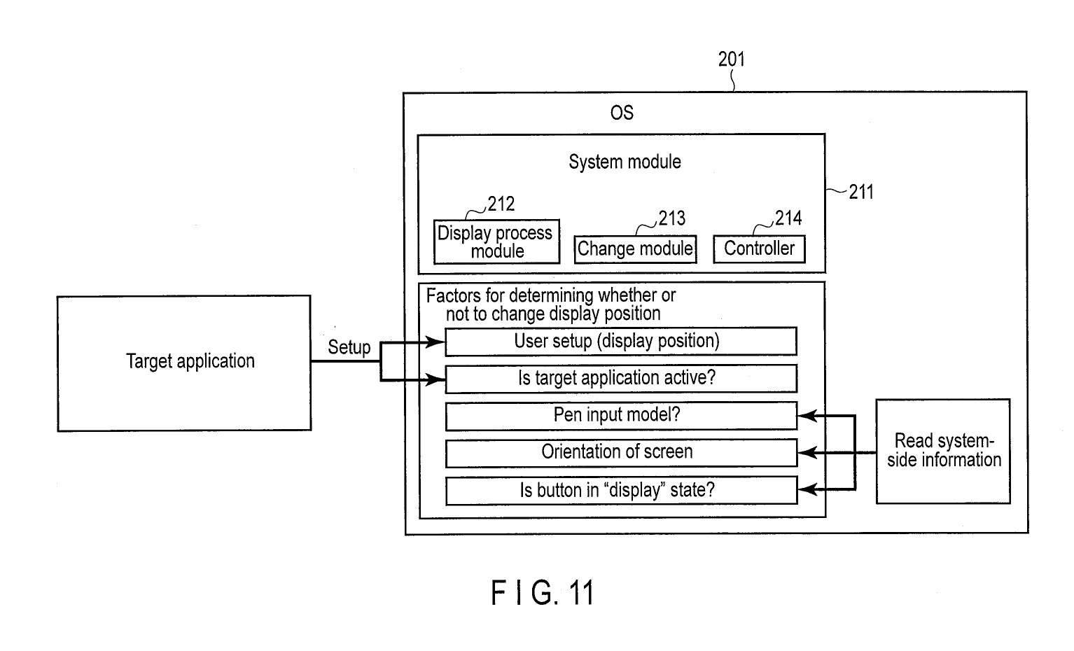

FIG. 11 illustrates an example of a cooperative operation between a target application program and the OS 201.

The case is now assumed that the OS 201 is Android™-OS, and a description is given of an example of the cooperative operation between the target application program and the OS 201. The target application program is, for example, an arbitrary application program which enables a handwriting input on the display area (content area) 51 of the screen. It is assumed that the target application program is the handwriting note application program 202.

The OS 201 includes a system module 211 for managing a user interface. The system module 211 is configured to execute a process of automatically changing the display location of software buttons, according to whether the target application program (in this example, the handwriting note application program 202) is active or not.

When the user has executed a setup operation of the display position of software buttons by using the button display position setup screen of FIG. 10, or when the handwriting note application 202 has been started up, the handwriting note application 202 sets up the display position of the software buttons in a storage area (system storage area) of the OS 201. For example, the handwriting note application program 202 stores a user setup value, which is indicative of the display position (center/left/right) of the software buttons, in a storage area (system storage area) of the system module 211.

The system module 211 can determine whether the handwriting note application program 202 is active or not. As the process of determining whether the handwriting note application program 202 is active or not, use may be made of an arbitrary process which can determine whether the handwriting note application program 202 is active or not. For example, when the handwriting note application program 202 transitions to the foreground (including when the handwriting note application program 202 is started up), the handwriting note application program 202 may store information, which indicates that the handwriting note application program 202 is active, in the system storage area. Further, when the handwriting note application program 202 transitions to the background, the handwriting note application program 202 may store information, which indicates that the handwriting note application program 202 is not active, in the system storage area.

The system module 211 may check the system storage area at regular intervals, for example, at each time of a refresh cycle of the screen. Thereby, the system module 211 can confirm the user setup value (center/left/right) of the software buttons and the active/inactive state of the handwriting note application program 202.

If the transition of the handwriting note application program 202 to the active state has been detected, the system module 211 displays the software buttons at a display location (center/left/right) which is designated by the user setup value. For example, if the display location, which is designated by the user setup value, is the left, the system module 211 changes the display location of the software buttons to the left side of the default display location, for example, to a left part of the bar 52. In addition, if the display location, which is designated by the user setup value, is the right, the system module 211 changes the display location of the software buttons to the right side of the default display location, for example, to a right part of the bar 52.

If the transition of the handwriting note application program 202 to the inactive state has been detected, the system module 211 restores the display location of the software buttons to the default display location.

Not only the active/inactive state of the handwriting note application program 202 but also the orientation of the screen (portrait or landscape) may be added to the factors for determining whether or not to change the display location of the software buttons.

As described above, the handwriting note application program 202 can display not only the above-described page edit screen which enables handwriting, but also other various screens. The tablet computer 10 includes a function of rotating the orientation of the screen so that the orientation of a screen image on the touch-panel display 17 may agree with the direction of gravity. However, as regards the page edit screen, there is a case that the orientation of the page edit screen should preferably be fixed at a portrait angle, because of the nature of this screen. In general, the occurrence of an unintentional touch operation needs to be suppressed at a time of a handwriting input operation (at time of displaying the page edit screen). Thus, the display position of the software buttons may be changed on the condition that the handwriting note application program 202 is active and the orientation of the screen is at the portrait angle. Thereby, even when the handwriting note application program 202 is active, the software buttons can be displayed at the default display location while an operation other than a handwriting input operation is being performed.

Besides, when the tablet computer 10 is not a pen input model including a digitizer, the function of changing the display position of software buttons may be disabled. In addition, in the case of such a state that software buttons are not displayed, there is no need to change the display position of software buttons. Thus, the display position of at least one software button may be changed on the condition that the handwriting note application program 202 is active, the orientation of the screen is at the portrait angle and at least one software button is being displayed.

The system module 211 may include, as functional modules thereof, a display process module 212, a change module 213 and a controller 214.

The display process module 212 functions as a display processor configured to display on the touch-screen display 17 the above-described screen including the display area 51, on which the content of the application program that is in the active state is displayed, and the bar 52 under the display area 51. Further, the display process module 212 displays the above-described software buttons (back button 52A, home button 52B and recent application button 52C) on the bar 52.

The change module 213 functions as a controller configured to change the display location of the software buttons on the bar 52 to either the right side or the left side of the default display location, responding to the detection of the transition to the active state (the transition to the foreground) of a specific application program (in this example, the handwriting note application program 202) which is configured to enable a handwriting input on the display area 51 of the screen. In addition, the change module 213 restores the display location of the software buttons on the bar 52 to the default display location, responding to the detection of the transition to the inactive state (the transition to the background) of the handwriting note application program 202.

The controller 214 is a module for realizing a memo function for easily leaving an image of a currently displayed screen as a memo. It is not always necessary that the controller 214 be provided in the system module 211. The controller 214 may be realized, for example, as one service program. When a specific operation, which is performed by the user, has been detected, the controller 214 captures the image of the currently displayed screen, and renders the handwriting note application program 202 active. The handwriting note application program 202 displays the captured image on the above-described page edit screen which enables drawing of handwritten strokes on this captured image. Thereby, the user can execute a handwriting input by the pen 100 on the currently displayed screen (captured image).

Next, examples of some typical screens, which are presented to the user by the handwriting note application program 202, will be described.

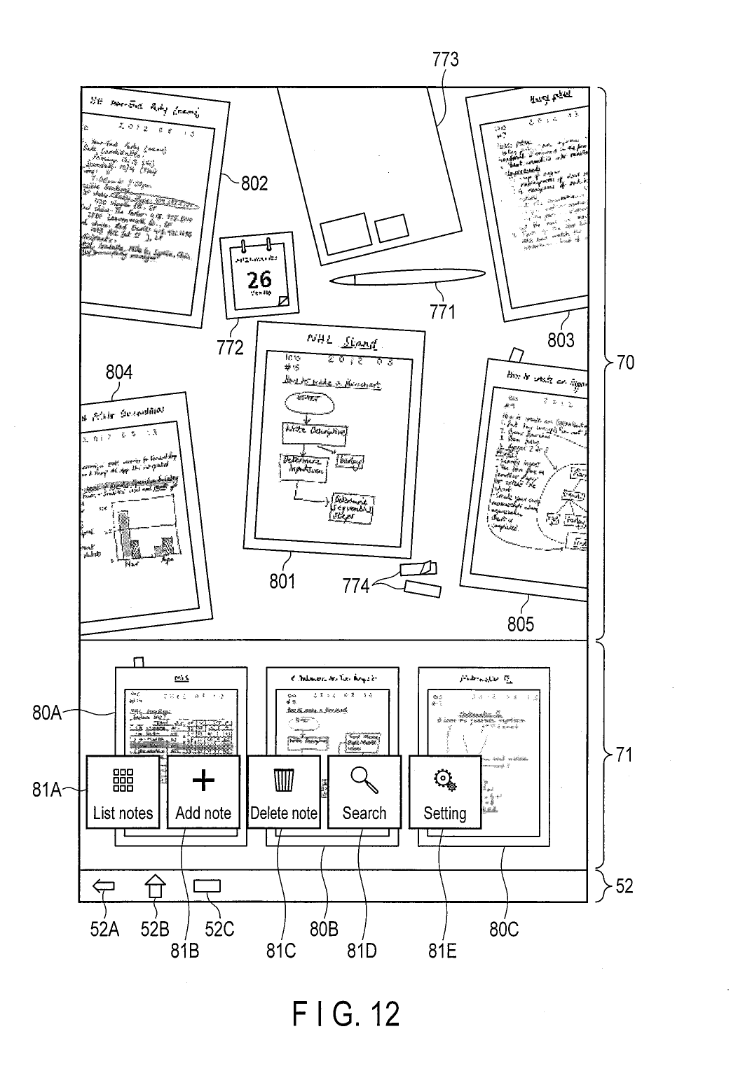

FIG. 12 shows a desktop screen which is displayed by the handwriting note application program 202. The desktop screen is a basic screen for handling a plurality of handwritten document data. In the description below, handwritten document data are referred to as “handwritten notes”.

The desktop screen includes a desktop screen area 70 and a drawer screen area 71. The desktop screen area 70 is a temporary area which displays a plurality of note icons 801 to 805 corresponding to a plurality of handwritten notes on which work is being done. Each of the note icons 801 to 805 displays a thumbnail of a certain page in a corresponding handwritten note. The desktop screen area 70 further displays a pen icon 771, a calendar icon 772, a scrap note (gallery) icon 773, and a tag (label) icon 774.

The pen icon 771 is a graphical interface (GUI) for switching the display screen from the desktop screen to a page edit screen. The calendar icon 772 is an icon indicative of the present date. The scrap note icon 773 is a GUI for viewing data (referred to as “scrap data” or “gallery data”) which is taken in from another application program or an external file. The tag icon 774 is a GUI for attaching a label (tag) to an arbitrary page in an arbitrary handwritten note.

The drawer screen area 71 is a display area for viewing a storage area for storing all handwritten notes which were created. The drawer screen area 71 displays note icons 80A, 80B and 80C corresponding to some handwritten notes of all handwritten notes. Each of the note icons 80A, 80B and 80C displays a thumbnail of a certain page in a corresponding handwritten note. The handwriting note application program 202 can detect a gesture (e.g. a swipe gesture) on the drawer screen area 71, which is performed by the user with use of the pen 100 or a finger. Responding to the detection of this gesture (e.g. a swipe gesture), the handwriting note application program 202 scrolls the screen image on the drawer screen area 71 to the left or to the right. Thereby, note icons corresponding to arbitrary handwritten notes can be displayed on the drawer screen area 71.

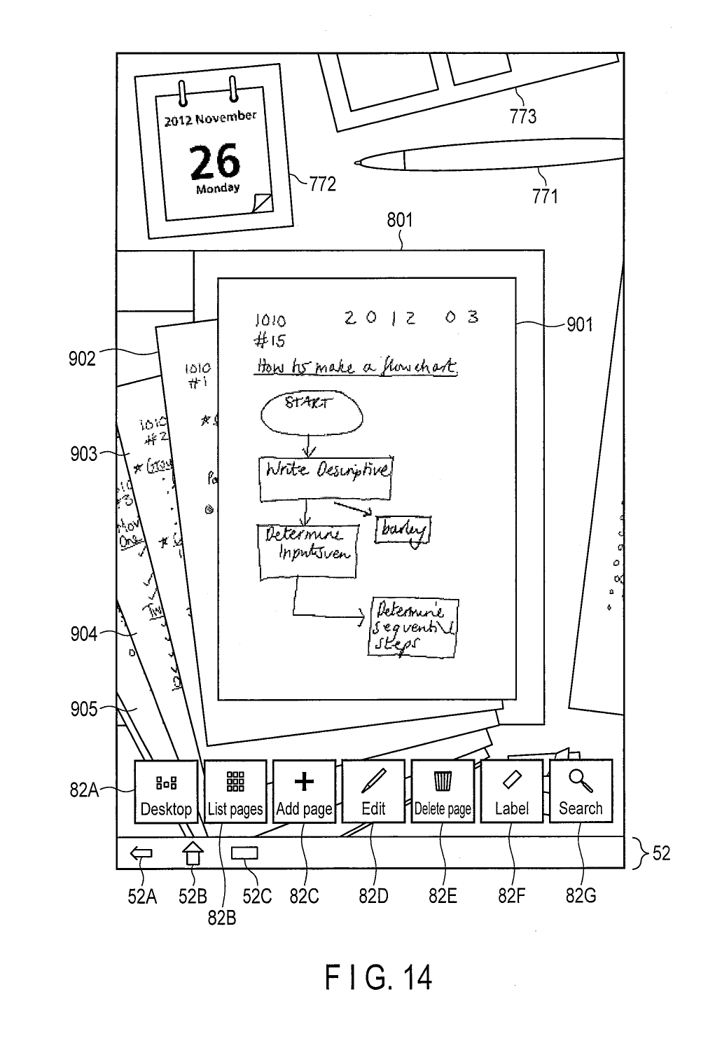

Further, the handwriting note application program 202 can detect a gesture (e.g. a tap gesture) on a note icon of the drawer screen area 71, which is performed by the user with use of the pen 100 or a finger. Responding to the detection of this gesture (e.g. a tap gesture) on a certain note icon on the drawer screen area 71, the handwriting note application program 202 moves this note icon to a central part of the desktop screen area 70. Then, the handwriting note application program 202 selects a handwritten note corresponding to this note icon, and displays a note preview screen shown in FIG. 14, in place of the desktop screen. The note preview screen of FIG. 14 is a screen which enables viewing of an arbitrary page in the selected handwritten note.

Moreover, the handwriting note application program 202 can also detect a gesture (e.g. a tap gesture) on the desktop screen area 70, which is performed by the user with use of the pen 100 or a finger. Responding to the detection of this gesture (e.g. a tap gesture) on a note icon which is located at the central part of the desktop screen area 70, the handwriting note application program 202 selects a handwritten note corresponding to the note icon located at the central part, and displays the note preview screen shown in FIG. 14, in place of the desktop screen.

Besides, the desktop screen can display a menu. This menu includes a list notes button 81A, an add note button 81B, a delete note button 81C, a search button 81D, and a setting button 81E. The list notes button 81A is a button for displaying a list of handwritten notes. The add note button 81B is a button for creating (adding) a new handwritten note. The delete note button 81C is a button for deleting a handwritten note. The search button 81D is a button for opening a search screen (search dialog). The setting button 81E is a button for opening a setup screen.

On the bar 52, the back button 52A, home button 52B and recent application button 52C are displayed. When the display position of the software buttons is preset at the left by the user's operation, the back button 52A, home button 52B and recent application button 52C are displayed on the left side of the default display location, that is, on a left part of the bar 52, as illustrated in FIG. 12.

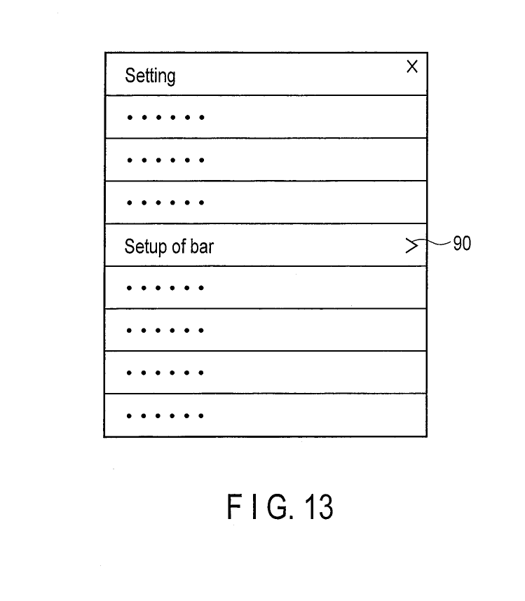

FIG. 13 illustrates a setup screen which is opened when the setting button 81E is tapped by the pen 100 or a finger.

The setup screen displays various setup items. These setup items include “setup of bar”. If a button 90 corresponding to the setup item “setup of bar” is tapped by the pen 100 or a finger, the button display position setup screen, which has been described with reference to FIG. 10, is displayed.

FIG. 14 illustrates the above-described note preview screen.

The note preview screen is a screen which enables viewing of an arbitrary page in a selected handwritten note. The case is now assumed that a handwritten note corresponding to the note icon 801 has been selected. In this case, the handwriting note application program 202 displays a plurality of pages 901, 902, 903, 904 and 905, which are included in this handwritten note, in such a mode that at least parts of these pages 901, 902, 903, 904 and 905 are visible and that these pages 901, 902, 903, 904 and 905 overlap each other.

The note preview screen further displays the above-described pen icon 771, calendar icon 772, scrap note icon 773, and tag icon 774.

The note preview screen can further display a menu. This menu includes a desktop button 82A, a list pages button 82B, an add page button 82C, an edit button 82D, a delete page button 82E, a label button 82F, and a search button 82G. The desktop button 82A is a button for displaying the desktop screen. The list pages button 82B is a button for displaying a list of pages in a currently selected handwritten note. The add page button 82C is a button for creating (adding) a new page. The edit button 82D is a button for displaying the page edit screen. The delete page button 82E is a button for deleting a page. The label button 82F is a button for displaying a list of kinds of usable labels. The search button 82G is a button for displaying the search screen.

On the bar 52, the back button 52A, home button 52B and recent application button 52C are displayed. When the display position of the software buttons is preset at the left by the user's operation, the back button 52A, home button 52B and recent application button 52C are displayed on the left side of the default display location, that is, on a left part of the bar 52, as illustrated in FIG. 14.

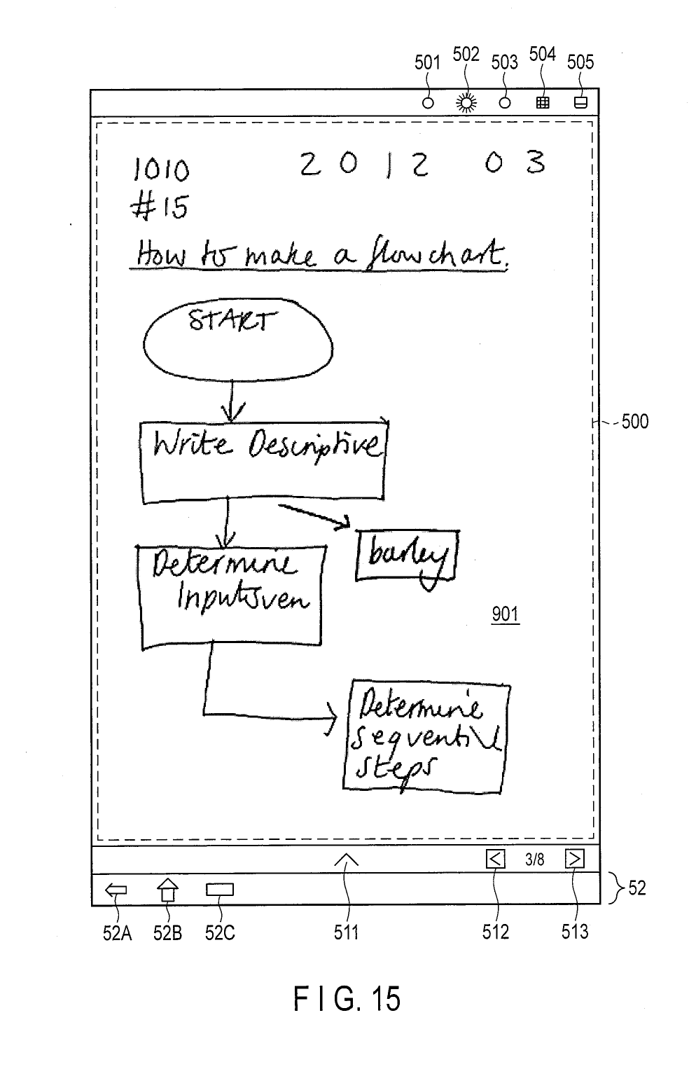

The handwriting note application program 202 can detect various gestures on the note preview screen, which are performed by the user. For example, responding to the detection of a certain gesture, the handwriting note application program 202 changes the page, which is to be displayed uppermost, to an arbitrary page (“page forward”, “page back”). In addition, responding to the detection of a certain gesture (e.g. a tap gesture) which is performed on the uppermost page, or responding to the detection of a certain gesture (e.g. a tap gesture) which is performed on the pen icon 771, or responding to the detection of a certain gesture (e.g. a tap gesture) which is performed on the edit button 82D, the handwriting note application program 202 selects the uppermost page, and displays a page edit screen shown in FIG. 15, in place of the note preview screen.

The page edit screen of FIG. 15 is a screen which enables creation of a new page (handwritten page), and viewing and edit of an existing page. When a page 901 on the note preview screen of FIG. 14 has been selected, the page edit screen displays the content of the page 901, as shown in FIG. 15.

On the page edit screen, a rectangular area 500, which is surrounded by a broken line, is a handwriting input area which enables a handwriting input. In the handwriting input area 500, an input event from the digitizer 17C is used for display (drawing) of handwritten strokes, and is not used as an event indicative of a gesture such as a tap. On the other hand, on the page edit screen, in an area other than the handwriting input area 500, an input event from the digitizer 17C may be used as an event indicative of a gesture such as a tap.

An input event from the touch panel 17B is not used for display (drawing) of handwritten strokes, but is used as an event indicative of a gesture such as a tap or a swipe.

The page edit screen further displays a quick select menu including three kinds of pens 501 to 503 which are pre-registered by the user, a range select pen 504 and an eraser pen 505. In this example, the case is assumed that a black pen 501, a red pen 502 and a marker 503 are pre-registered by the user. By tapping a pen (button) in the quick select menu by the pen 100 or a finger, the user can change the kind of pen that is used. For example, if a handwriting input operation using the pen 100 is executed on the page edit screen in the state in which the black pen 501 is selected by a tap gesture with use of the pen 100 or a finger by the user, the handwriting note application program 202 displays on the page edit screen a black stroke (locus) in accordance with the movement of the pen 100.

The above-described three kinds of pens in the quick select menu can also be switched by an operation of a side button of the pen 100. Combinations of frequently used pen colors and pen thicknesses can be set for the above-described three kinds of pens in the quick select menu.

The page edit screen further displays a menu button 511, a page back button 512, and a page forward button 513. The menu button 511 is a button for displaying a menu.

This menu may include, for example, a button for returning to the note preview screen, a button for adding a new page, and a search button for opening a search screen. This menu may further include a sub-menu for export or import. As the sub-menu for export, use may be made of a menu for prompting the user to select a function of recognizing a handwritten page which is displayed on the page edit screen, and converting the handwritten page to an electronic document file or a presentation file.

Furthermore, the menu may include a button for starting a process of converting a handwritten page to text, and sending the text by e-mail. Besides, the menu may include a button for calling a pen setup screen which enables a change of the colors (colors of lines to be drawn) and thicknesses (thicknesses of lines to be drawn) of the three kinds of pens in the quick select menu.

On the bar 52, the back button 52A, home button 52B and recent application button 52C are displayed. When the display position of the software buttons is preset at the left by the user's operation, the back button 52A, home button 52B and recent application button 52C are displayed on the left side of the default display location, that is, on a left part of the bar 52, as illustrated in FIG. 15.

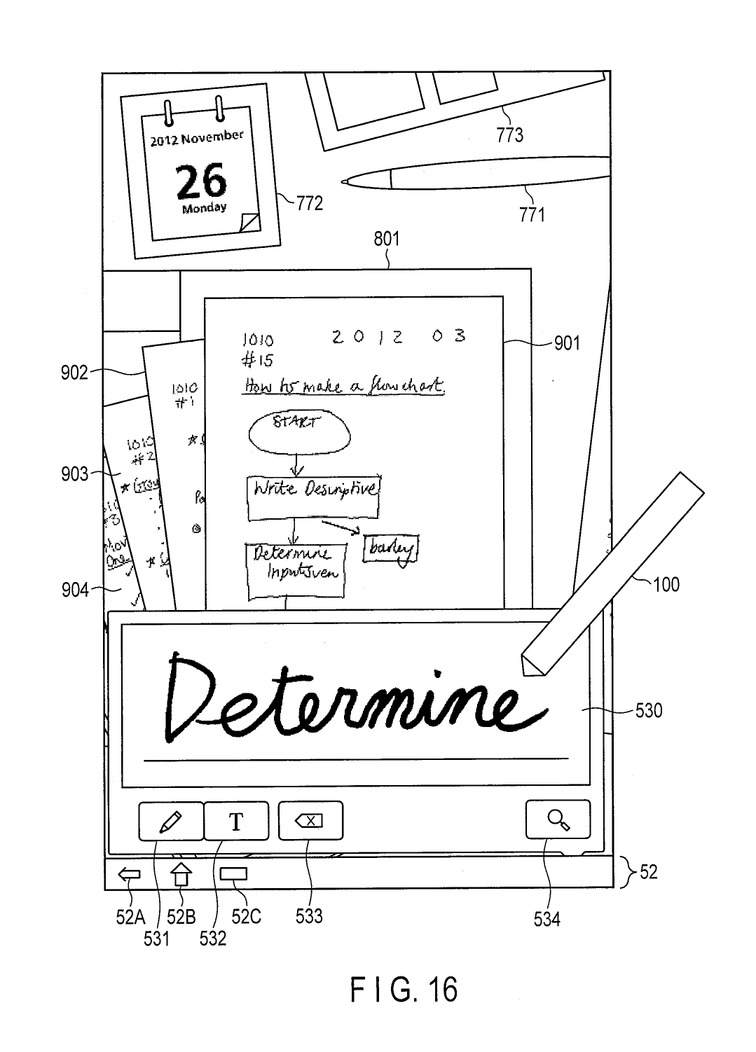

FIG. 16 illustrates an example of the search screen (search dialog). In FIG. 16, the case is assumed that the search screen (search dialog) is opened on the note preview screen.

The search screen displays a search key input area 530, a handwriting search button 531, a text search button 532, a delete button 533 and a search execution button 534. The handwriting search button 531 is a button for selecting a handwriting search. The text search button 532 is a button for selecting a text search. The search execution button 534 is a button for requesting execution of a search process.

In the handwriting search, the search key input area 530 is used as an input area for handwriting a character string, a graphic or a table, which is to be used as a search key. FIG. 16 illustrates, by way of example, a case in which a handwritten character string “Determine” has been input to the search key input area 530 as a search key. The user can handwrite, as well as a handwritten character string, a handwritten graphic or a handwritten table in the search key input area 530 by using the pen 100. If the search execution button 534 is selected by the user in the state in which the handwritten character string “Determine” has been input to the search key input area 530 as a search key, a handwriting search is executed for searching for a handwritten note including strokes corresponding to query strokes by using strokes (query strokes) of the handwritten character string “Determine”. In the handwriting search, strokes similar to the query strokes are searched by matching between strokes. DP (Dynamic Programming) matching may be used in calculating the similarity between query strokes and other strokes.

In the text search, for example, a software keyboard is displayed on the screen. By operating the software keyboard, the user can input arbitrary text (character string) to the search key input area 530 as a search key. If the search execution button 534 is selected by the user in the state in which the text has been input to the search key input area 530 as a search key, a text search is executed for searching for a handwritten note including strokes corresponding to this text (query text).

The handwriting search/text search can be executed for a target which is all handwritten notes, or for a target which is only a selected handwritten note. If the handwriting search/text search is executed, a search result screen is displayed. The search result screen displays a list of handwritten pages including strokes corresponding to query strokes (or query text). Hit words (strokes corresponding to query strokes or query text) are displayed with emphasis.

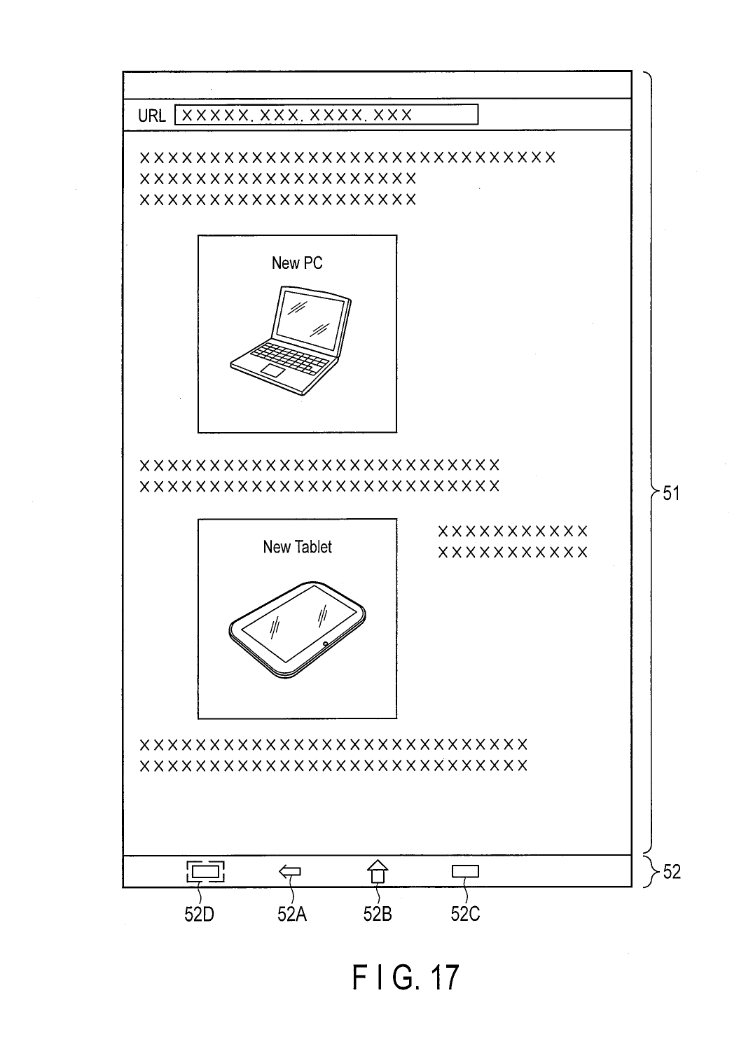

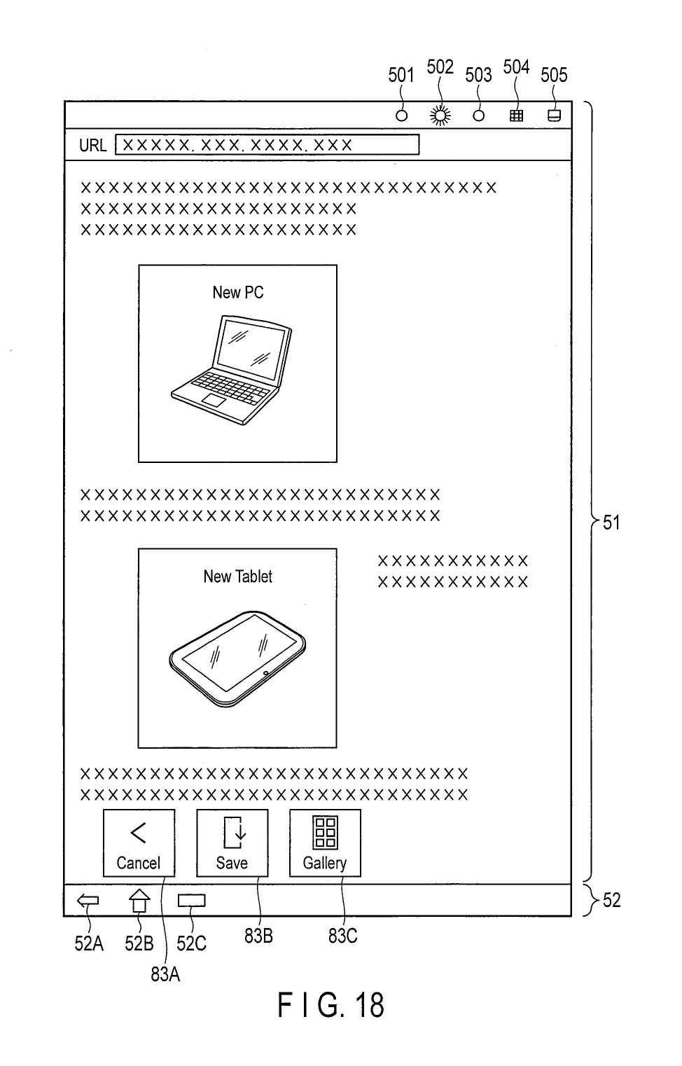

Next, referring to FIG. 17 and FIG. 18, the above-mentioned memo function will be described.

FIG. 17 illustrates a screen corresponding to an application program other than the handwriting note application program 202. The case is now assumed that this other application program is a browser (Web browser). The Web browser displays content, such as a Web page, on the display area 51 on the screen. On the bar 52, a software button (back button 52A, home button 52B or recent application button 52C) is displayed at a default display location (in this example, the central part of the bar 52). Further, on the bar 52, a memo button 52D is also displayed. The memo button 52D is a button for executing the above-described memo function.

If a gesture (tap gesture) on the memo button 52D by the pen 100 or a finger is detected, the above-described controller 214 captures an image corresponding to the content on the display area 51. Then, the controller 214 calls the handwriting note application 202 and renders the handwriting note application 202 active. The handwriting note application 202 opens a page edit screen (memo screen) and displays the captured image, which is received from the controller 214, on the page edit screen (memo screen).

An example of this memo screen is illustrated in FIG. 18.

On the bar 52, the display location of three software buttons (back button 52A, home button 52B and recent application button 52C) is automatically changed. Further, the memo button 52D is deleted from the bar 52.

On the memo screen, the captured image (the screen image of the Web page) is displayed on the display area 51. Further, a black pen button 501, a red pen button 502, a marker button 503, a select button 504 and an eraser pen 505 are displayed. In the display area 51, a transparent layer (handwriting layer) is set on the captured image. Each of strokes handwritten by the user is drawn on the handwriting layer. Thereby, each stroke (the locus of each stroke) is displayed on the screen image of the Web page. Since the display location of the software buttons has already been changed, it is possible to prevent occurrence of an unintentional touch operation.

The memo screen can also display a menu. This menu includes a cancel button 83A, a save button 83B and a gallery button 83C. The cancel button 83A is a button for canceling the creation of a memo and returning to the original screen (in this example, the screen of the Web page). The save button 83B is a button for saving a memo (the content of the memo screen) and returning to the original screen (in this example, the screen of the Web page). If the save button 83B is tapped, the handwriting note application program 202 generates handwritten page data which includes image data corresponding to the captured image and at least one stroke data corresponding to at least one handwritten stroke on the captured image, and stores this handwritten page data in a storage medium as gallery data. Incidentally, the screen image of the memo screen may be stored in the storage medium as gallery data. The gallery button 83C is a button for saving the memo (the content of the memo screen) and opening a list of gallery data.

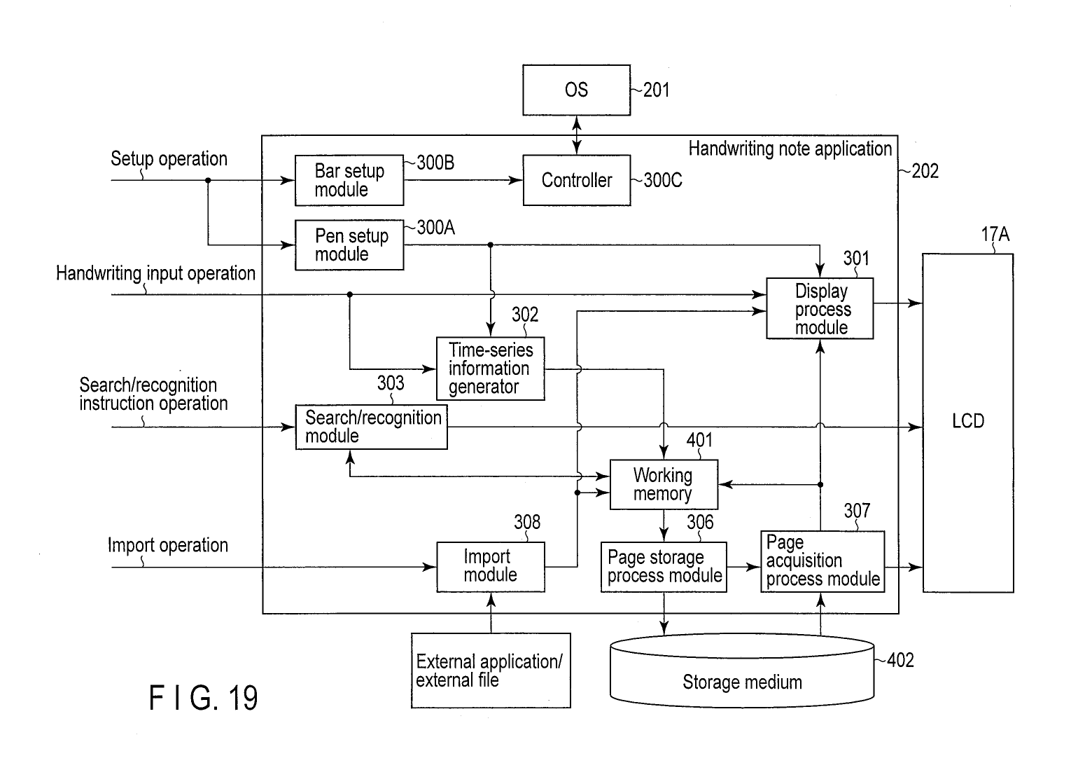

Next, referring to FIG. 19, a description is given of a functional configuration of the handwriting note application program 202.

The handwriting note application program 202 is a WYSIWYG application which can handle handwritten document data. The handwriting note application program 202 includes, for example, a pen setup module 300A, a bar setup module 300B, a controller 300C, a display process module 301, a time-series information generator 302, a search/recognition module 303, a page storage process module 306, a page acquisition process module 307, and an import module 308.

The above-described touch panel 17B is configured to detect the occurrence of events such as “touch (contact)”, “move (slide)” and “release”. The “touch (contact)” is an event indicating that an object (finger) has come in contact with the screen. The “move (slide)” is an event indicating that the position of contact of the object (finger) has been moved while the object (finger) is in contact with the screen. The “release” is an event indicating that the object (finger) has been released from the screen.

The above-described digitizer 17C is also configured to detect the occurrence of events such as “touch (contact)”, “move (slide)” and “release”. The “touch (contact)” is an event indicating that an object (pen 100) has come in contact with the screen. The “move (slide)” is an event indicating that the position of contact of the object (pen 100) has been moved while the object (pen 100) is in contact with the screen. The “release” is an event indicating that the object (pen 100) has been released from the screen.

The handwriting note application program 202 displays on the touch-screen display 17 a page edit screen for creating, viewing and editing handwritten page data. The pen setup module 300A displays a user interface (e.g. the above-described plural pen icons, or a menu screen for setting up details of pen styles), and sets up a mode of drawing of strokes in accordance with an operation on the user interface, which is performed by the user.

The bar setup module 300B displays the button display position setup screen which has been described with reference to FIG. 10, and sets up the display position of the software buttons of the OS 201 in accordance with an operation on the button display position setup screen, which is performed by the user. The controller 300C communicates with the system module 211 in the OS 201.

The display process module 301 and time-series information generator 302 receive an event of “touch (contact)”, “move (slide)” or “release”, which is generated by the digitizer 17C, thereby detecting a handwriting input operation. The “touch (contact)” event includes coordinates of a contact position. The “move (slide)” event includes coordinates of a contact position at a destination of movement. Accordingly, the display process module 301 and time-series information generator 302 can receive coordinate series corresponding to the locus of movement of the contact position from the digitizer 17C.

The display process module 301 displays on the screen handwritten strokes in accordance with the movement of the object (pen 100) on the screen, which is detected by using the digitizer 17C. By the display process module 301, the locus of the pen 100 during a time in which the pen 100 is in contact with the screen, that is, the locus of each stroke, is displayed on the page edit screen. Further, the display process module 301 can display on the page edit screen various content data (image data, audio data, text data, and data created by a drawing application) which are imported from an external application/external file by the import module 308.

The time-series information generator 302 receives the above-described coordinate series which are output from the digitizer 17C, and generates, based on the coordinate series, handwritten data which includes the time-series information (coordinate data series) having the structure as described in detail with reference to FIG. 4. The time-series information generator 302 temporarily stores the generated handwritten data in a working memory 401.

The search/recognition module 303 executes a handwriting recognition process of converting a handwritten character string in the handwritten page data to text (character code string), and a character recognition process (OCR) of converting a character string included in an image in the handwritten page data to text (character code string). Further, the search/recognition module 303 can execute the above-described handwriting search and text search.

The page storage process module 306 stores in a storage medium 402 handwritten page data including plural stroke data corresponding to plural handwritten strokes on the handwritten page that is being created. The storage medium 402 may be, for example, the storage device in the tablet computer 10, or the storage device in the server computer 2.

The page acquisition process module 307 acquires arbitrary handwritten page data from the storage medium 402. The acquired handwritten page data is sent to the display process module 301. The display process module 301 displays on the screen a plurality of strokes corresponding to plural stroke data included in the handwritten page data.

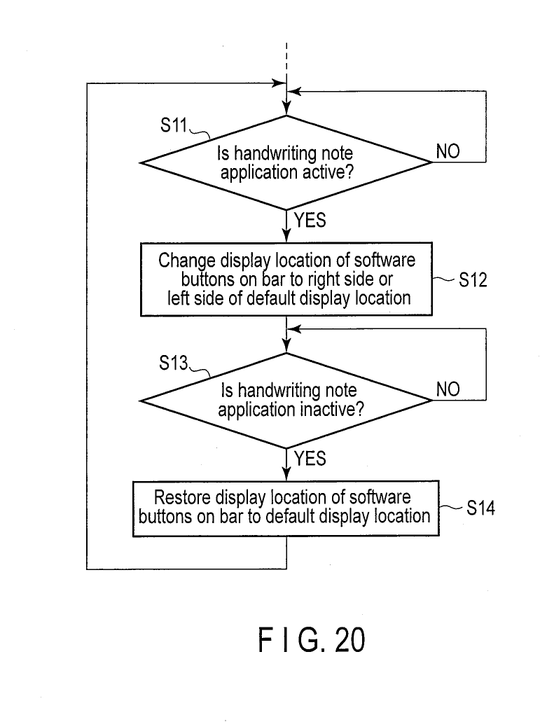

A flowchart of FIG. 20 illustrates the procedure of a software button display control process which is executed by the system module 211.

The case is now assumed that a user setup value, which is indicative of the display position (left or right) of the software buttons, has already been stored in the system storage area by the handwriting note application program 202.

The system module 211 determines whether the handwriting note application program 202 is active or not, that is, whether the handwriting note application program 202 has transitioned to the foreground (including whether the handwriting note application program 202 has been started up) (step S11). If the handwriting note application program 202 is active, that is, if the handwriting note application program 202 has transitioned to the foreground, the system module 211 changes the display location of the software buttons on the bar 52 to the right side or left side of the default display location (step S12).

Thereafter, the system module 211 determines whether the handwriting note application program 202 is inactive or not, that is, whether the handwriting note application program 202 has transitioned to the background (step S13). If the handwriting note application program 202 is inactive, that is, if another application program is active, the system module 211 restores the display location of the software buttons on the bar 52 to the default display location (step S14).

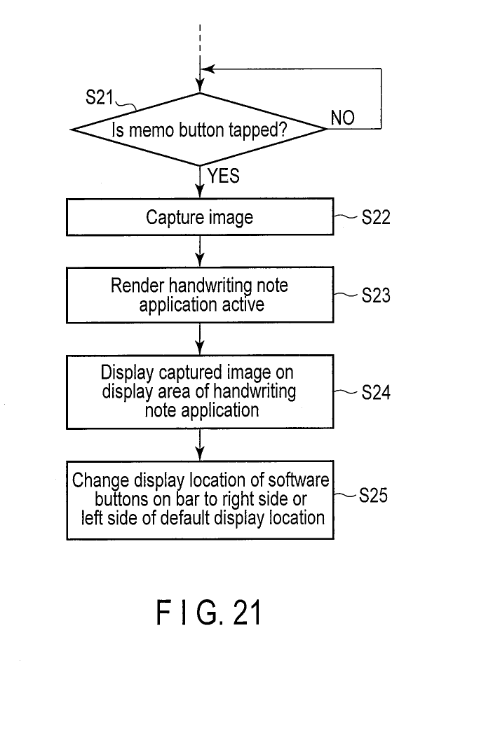

A flowchart of FIG. 21 illustrates the procedure of a series of processes which are executed in response to an operation of the above-described memo button 52D.

If the memo button 52D is tapped by the pen 100 or a finger (YES in step S21), the controller 214 of the system module 211 captures an image corresponding to the content which is currently displayed on the display area 51 (step S22). In step S22, a snapshot corresponding to the screen image on the display area 51 is generated as the image corresponding to the content which is currently displayed.

Then, the controller 214 of the system module 211 calls the handwriting note application 202 and renders the handwriting note application 202 active (step S23). The handwriting note application 202 opens a page edit screen (memo screen) and displays the captured image, which is received from the controller 214, on the display area of the memo screen which enables a handwriting input on this captured image (step S24). The change module 213 of the system module 211 detects that the handwriting note application program 202 has become active, and changes the display location of the software buttons on the bar 52 to either the right side or the left side of the default display location (step S25). In step S25, the change module 213 turns off the display of the memo button 52D.

As has been described above, in the embodiment, when an application program (in this example, the handwriting note application program 202), which enables a handwriting input on the display area of the screen, is active, the display location of the software buttons on the bar 62 is automatically changed to either the right side or the left side of the default display location. It is thus possible to suppress the occurrence of an unintentional touch operation during a handwriting input operation, without disabling functions assigned to the software buttons.

In the meantime, there is a case in which, for example, an icon for status display, which does not react to a contact, is displayed on the bar 62. The display position of the icon for status display may not necessarily be changed.

Since the various processes of the embodiment can be realized by a computer program, the same advantageous effects as with the present embodiment can easily be obtained simply by installing the computer program into an ordinary computer through a computer-readable storage medium which stores the computer program, and executing the computer program.

The various modules of the systems described herein can be implemented as software applications, hardware and/or software modules, or components on one or more computers, such as servers. While the various modules are illustrated separately, they may share some or all of the same underlying logic or code.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. An electronic device comprising:
a display processor configured to display, on a touch-screen display, a content in a display area and a bar comprising at least one first software button of an operating system at a first location on the bar, wherein the bar is located under the display area; and
a first controller configured to change a display location of the first software button on the bar to either a right side or a left side of the first location, in response to detection of a transition to an active state of a first application program configured to enable a handwriting input on the display area.

2. The electronic device of claim 1,
wherein the first application program is configured to set up the display location of the software button in accordance with an operation which is performed by a user, and
the first controller is configured to change the display location of the first software button on the bar to either the right side or the left side of the first location, in accordance with the setting-up.

3. The electronic device of claim 1, wherein the first controller is configured to restore the display location of the first software button to the first location, in response to detection of a transition to an inactive state of the first application program.

4. The electronic device of claim 1, further comprising a second controller configured to capture an image corresponding to content displayed by another application program which is different from the first application program and to render the first application program active, in response to detection of a first operation performed by a user while said another application program is in an active state,
wherein the first application program is configured to display the captured image on the display area configured to enable a handwriting input on the image.

5. The electronic device of claim 4, wherein said another application program is a browser.

6. The electronic device of claim 4, wherein the first operation is a gesture on a second software button which is displayed on the bar.

7. The electronic device of claim 6, wherein the first controller is configured to turn off display of the second software button and to change the display location of the first software button to either the right side or the left side of the first location, in response to detection of the transition to the active state of the first application program.

8. The electronic device of claim 4, wherein the first application program is configured to store in a storage medium a handwritten document including image data corresponding to the image and stroke data corresponding to handwritten strokes on the image.

9. A method comprising:
displaying, on a touch-screen display of an electronic device, a content in a display area and a bar comprising at least one first software button of an operating system at a first location on the bar, wherein the bar is located under the display area; and
changing a display location of the first software button on the bar to either a right side or a left side of the first location, in response to detection of a transition to an active state of a first application program configured to enable a handwriting input on the display area.

10. The method of claim 9, further comprising setting up the display location of the software button in accordance with an operation which is performed by a user,
wherein said changing includes changing the display location of the first software button on the bar to either the right side or the left side of the first location, in accordance with the setting-up.

11. The method of claim 9, further comprising restoring the display location of the first software button to the first location, in response to detection of a transition to an inactive state of the first application program.

12. The method of claim 9, further comprising:
in response to detection of a first operation performed by a user while another application program is in an active state, said another application program being different from the first application program:
capturing an image corresponding to content displayed by said another application program; and
rendering the first application program active,
wherein the first application program displays the captured image on the display area configured to enable a handwriting input on the image.

13. A computer-readable, non-transitory storage medium having stored thereon a computer program which is executable by a computer, the computer program controlling the computer to execute functions of:
displaying, on a touch-screen display of the computer, a content in a display area and a bar comprising at least one first software button of an operating system at a first location on the bar, wherein the bar is located under the display area; and
changing a display location of the first software button on the bar to either a right side or a left side of the first location, in response to detection of a transition to an active state of a first application program configured to enable a handwriting input on the display area.

14. The storage medium of claim 13, wherein the computer program further controls the computer to execute a function of setting up the display location of the software button in accordance with an operation which is performed by a user, and
wherein said changing includes changing the display location of the first software button on the bar to either the right side or the left side of the first location, in accordance with the setting-up.

15. The storage medium of claim 13, wherein the computer program further controls the computer to execute a function of restoring the display location of the first software button to the first location, in response to detection of a transition to an inactive state of the first application program.

16. The storage medium of claim 13, wherein the computer program further controls the computer to execute functions of:
in response to detection of a first operation performed by a user while another application program is in an active state, said another application program being different from the first application program,
capturing an image corresponding to content displayed by said another application program; and
rendering the first application program active,
wherein the first application program displays the captured image on the display area configured to enable a handwriting input on the image.
